(19) United States
(12) Patent Application Publication
(10) Pub. No.: US 2011/0042575 A1
(43) Pub. Date: Feb. 24, 2011

(54) Semiconductor Detector Block and Positron Emission Tomography Device Using the Same

(75) Inventors: Keizo Ishii, Miyagi (JP); Youhei Kikuchi, Miyagi (JP); Shigeo Matsuyama, Miyagi (JP); Hiromichi Yamazaki, Miyagi (JP)

Correspondence Address: IPUSA, P.L.L.C, 1054 31ST STREET, N.W., Suite 400, Washington, DC, 20007, US

(73) Assignee: SUMITOMO HEAVY INDUSTRIES, LTD., TOKYO (JP)

(21) Appl. No.: 12/988,698

(22) PCT Filed: Apr. 24, 2008
(86) PCT No.: PCT/JP2008/057968

§ 371 Date: Oct. 20, 2010

(51) Int. Cl. G01T 1/24; G01T 1/29

(52) U.S. Cl. 250/370.08; 250/370.1

(57) ABSTRACT

A disclosed semiconductor detector block includes a plurality of semiconductor plates each configured to have a front surface on which an electrically resistive electrode is formed and a back surface on which an electrically conductive electrode is formed and to detect a two-dimensional detection position of gamma rays on the semiconductor plates using a ratio of electric signals from four corners of the electrically resistive electrode, wherein the plurality of semiconductor plates are piled up and a three-dimensional detection position of the gamma rays is detectable using a ratio of the electric signals from the four corners of the electrically resistive electrodes.

### CROSS-REFERENCE TO RELATED APPLICATIONS

This application is a U.S. continuation application filed under 35 USC 111a and 365c of PCT application JP2008/057968, filed Apr. 24, 2008. The foregoing application is hereby incorporated herein by reference.

### BACKGROUND OF THE INVENTION

1. Field of the Invention

The present invention generally relates to a semiconductor detector block used for a positron emission tomography device which may be provided for making a diagnosis of cancers or organs like a brain while administering an agent containing a positron-emitting radionuclide, to a positron emission tomography apparatus for development of agents with animal experiments or the like, and to a positron emission tomography apparatus using the semiconductor detector block.

2. Description of the Related Art

A positron emission tomography apparatus detects two gamma rays, each having energy of 511 keV with an angle of 180 degrees between the directions of the two gamma rays, which are emitted when discharged positrons from a positron-emitting radionuclide and electrons in a substance meet and annihilate one another, and the apparatus acquires a distributional image from the detected two gamma rays. In positron emission tomography apparatuses, a scintillator made of bismuth germanium oxide (BGO), lutetium orthosilicate (LSO), scintillation gadolinium silicate (GSO), or the like is used as detectors for the gamma rays. The scintillator detectors may be arranged on a circumference of a gantry of a positron emission tomography apparatus. Several tens of scintillator detectors are bundled interposing light blocking walls among the scintillator detectors, and end portions of the scintillator detectors are connected to plural photomultiplier tubes (PMT). The scintillator detectors which detect the gamma rays are determined based on intensity ratios among receiving lights from the plural photomultiplier tubes (PMT) which are configured to multiply light generated by the scintillator detectors. An example of the positron emission tomography apparatus using the above principle has the minimum spatial resolution of several millimeters.

The example scintillator has a position resolution in travelling directions of gamma rays depending greatly on the sizes of the scintillators of the scintillator detectors facing the travelling directions. The sizes of the scintillators are ordinarily about 2 mm. Further, the detected positions in the travelling directions of the gamma rays are not directly measured. Therefore, other scintillators having a different attenuation time for the lights generated by the detected rays from an attenuation time of the scintillators are arranged in addition to the scintillators to enable determination of the positions of the gamma rays. The accuracy of the position resolution is several millimeters.

Although there are proposed examples of semiconductor detectors using Ge, Si, or the like, these examples need cooling with liquid nitrogen and an absorption effect for gamma rays having energies of 511 keV is insufficient since the atomic numbers of Ge and Si are smaller than the atomic number of the CdTe. Therefore, it is difficult to use Ge and Si for the semiconductor detectors of the positron emission tomography apparatus.

### SUMMARY OF THE INVENTION

Accordingly, it is a general object of the present invention to provide a novel and useful semiconductor detector block having a simple detector structure and performing a measurement with a spatial resolution (the accuracy of the position resolution) of 1 mm or less, and a positron emission tomography apparatus having the semiconductor detector block.

In order to solve the above problem, one aspect of the present invention is to provide the following semiconductor detector block and a positron emission tomography apparatus having the semiconductor detector block.

(1) A semiconductor detector block including a plurality of semiconductor plates configured to have a front surface on which an electrically resistive electrode is formed and a back surface on which an electrically conductive electrode is formed and to detect a two-dimensional detection position of gamma rays on each of the semiconductor plates using a ratio of electric signals from four corners of the electrically resistive electrode, wherein the plurality of semiconductor plates are piled up and a three-dimensional detection position of the gamma rays is detectable using a ratio of the electric signals from the four corners of the electrically resistive electrodes.

(2) The semiconductor detector block according to (1), wherein a Schottky junction is formed between the electrically resistive electrode and each of the semiconductor plates.

(3) The semiconductor detector block according to (1) or (2), wherein the electrically resistive electrode is made of indium, the semiconductor plates are made of a CdTe crystal or a BrTl crystal, and the electrically conductive electrode is made of platinum.

(4) The semiconductor detector block according to (3), wherein faces of the electrically conductive electrodes of the adjacent semiconductor plates are connected by an electroconductive paste, and the electrically resistive electrodes are piled up interposing an insulating film between surfaces of the electrically resistive electrodes.

(5) The semiconductor detector block according to any one of (1) through (4), wherein an electrical signal from the electrically conductive electrodes of one of the semiconductor plates is used as a time signal to determine a coincidence measurement with the other semiconductor plates.

(6) A positron emission tomography apparatus including the two or more semiconductor detector blocks according to any one of (1) through (5).

(7) The positron emission tomography apparatus according to (6), wherein the semiconductor detector blocks are independently movable in moving radius directions around a subject or directions facing the subject.

Additional objects and advantages of the embodiments are set forth in part in the description which follows, and in part will become obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a view of a semiconductor detector which can detect a two-dimensional detection position of gamma rays on a semiconductor plate of the semiconductor detector according to the present invention.

FIG. 2 is views for illustrating an experimental positional discrimination capability of a CdTe detector.

FIG. 3 is a view for illustrating a CdTe detector block according to the present invention.

FIG. 4 is a schematic view for illustrating an arrangement of CdTe detector blocks with a packing ratio of 100% in a positron emission tomography apparatus.

### DETAILED DESCRIPTION OF THE PREFERRED EMBODIMENTS

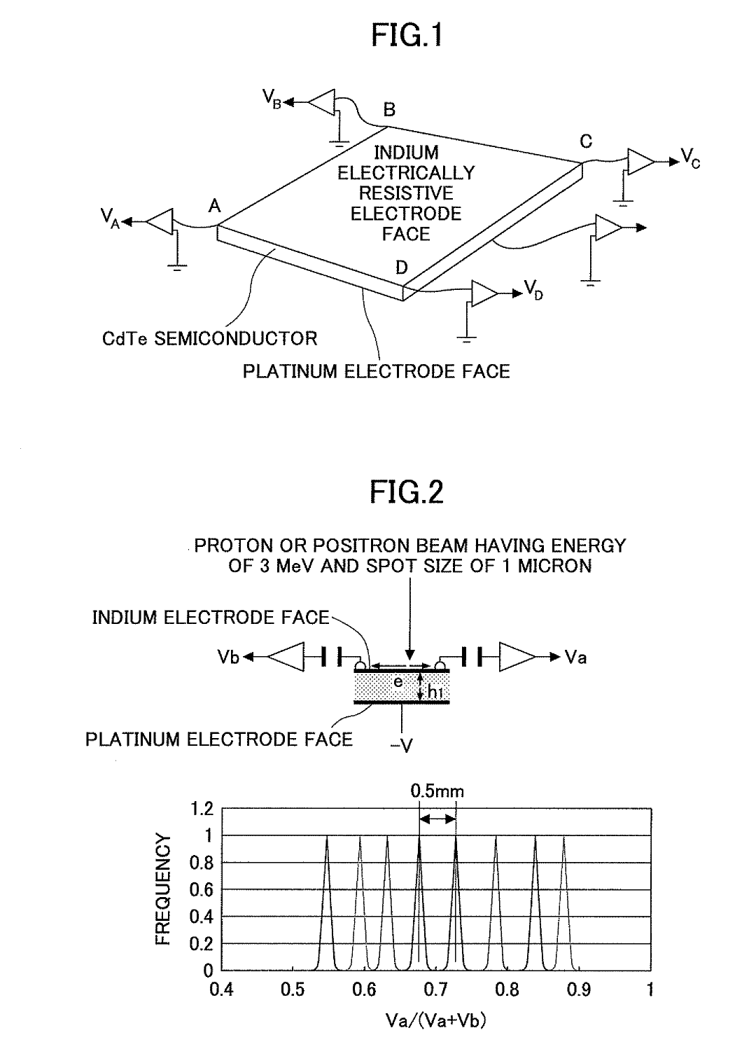

A description is given below, with reference to the FIG. 1 through FIG. 4 of embodiments of the present invention.

Reference symbols typically designate as follows:
1: Indium electrically resistive electrode face;
2: Platinum electrically conductive electrode face;
3: Insulating thin film;
4: Terminal of indium electrically resistive electrode face; and
5: Terminal of platinum electrically conductive electrode face.

A semiconductor detector block which can measure a three-dimensional position of gamma rays will be described in detail with reference to the figures. FIG. 1 illustrates a semiconductor detector which can detect a two-dimensional detection position of gamma rays on a semiconductor plate of the semiconductor detector. Referring to FIG. 1, a material of the thin semiconductor crystal plate is a CdTe crystal or a BrTl crystal. One face of the thin semiconductor crystal plate has an electrically resistive electrode, and the other face of the thin semiconductor crystal plate has an electrically conductive electrode.

The semiconductor detector is formed by terminals provided at four corners of the face on which the electrically resistive electrode is formed, and the terminals are connected to amplifying circuits. It is possible to obtain detection positions X and Y of the gamma rays on the semiconductor plate using voltages V_{A}, V_{B}, V_{C}, and V_{D} generated in the four terminals.

In order to process the semiconductor plate made of the CdTe crystal to produce a Schottky type detector, a platinum electrode is provided on one face of the semiconductor plate and an indium electrode is provided on the other face of the semiconductor plate. Electric resistivity is given to the indium electrode face by depositing a thin indium film. With this, the face of the semiconductor plate on which indium is deposited has electric resistivity, and the semiconductor plate may function as a Schottky type detector.

Then, a piece of CdTe crystal having a size of 10 mm×10 mm×1 mm is prepared. Then, capability of positional discrimination is tested while changing the thickness of the indium electrode face formed on the piece of CdTe. The capability of positional discrimination was the best when the thickness of the indium electrode face is 600 Å. Referring to FIG. 2, two of the four terminals in the four corners of the indium electrode face are drawn as indicated by Va and Vb, and one terminal is connected to the platinum electrode face. The piece of the CdTe crystal having the indium electrode face is irradiated by proton beams having a spot size of 1 micron (1 μm) at an interval of 0.5 mm. The frequencies observed with respect to values of Va/(Va+Vb) are illustrated in FIG. 2.

Referring to FIG. 2, the positional resolution of 0.2 mm or more was obtainable by the above semiconductor detector (the piece of the CdTe crystal having the indium electrode face).

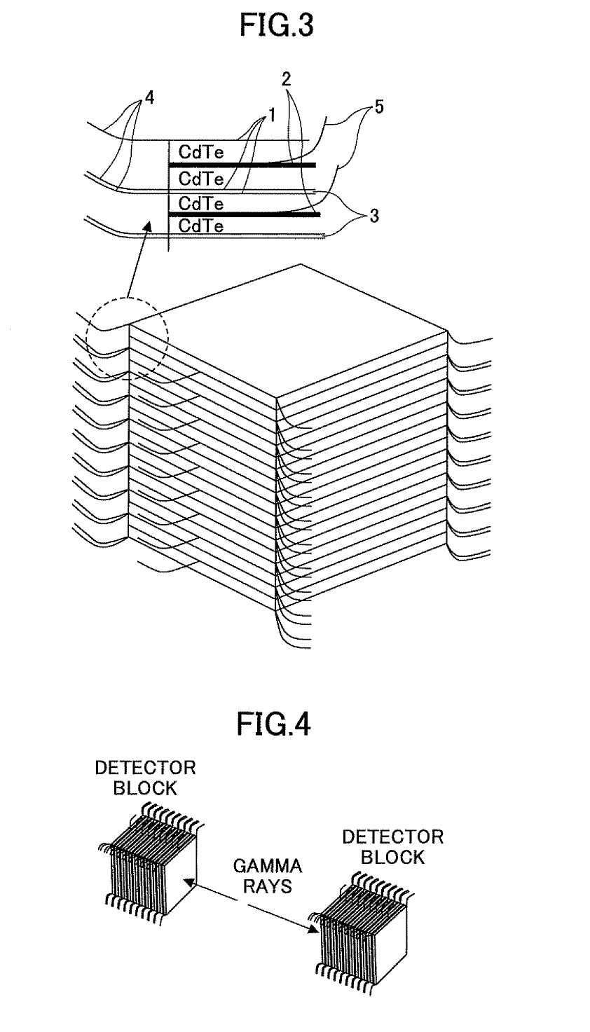

The lower part of FIG. 3 is a perspective view of the semiconductor detector block, and the upper part of FIG. 3 is a cross-sectional view of a part of the left upper portion of the semiconductor detector block. Peripheral devices such as the amplifiers are omitted in FIG. 3. The semiconductor detector block is fabricated as follows. The platinum electrode faces 2 of the semiconductor plates made of the CdTe crystal are pasted to one another by a paste having electrical conductivity. The pasted semiconductor plates are piled on interposing insulating thin films 3. Thus, a semiconductor detector block, which has mechanical strength and can measure three-dimensional positions of gamma rays using the number of the piled semiconductor plates penetrated by the gamma rays with a high spatial resolution, is fabricated even though the semiconductor plates (CdTe crystal) have insufficient mechanical strength.

It is determined which semiconductor plate among the semiconductor plates forming the semiconductor detector block receives the gamma rays by coincidence measurements using the platinum electrodes and the indium electrically resistive electrodes.

Next, applying the semiconductor detector block to a positron emission tomography apparatus is described. One or piled plural semiconductor detector blocks having sizes of 10 mm×10 mm×18 mm are arranged to form a circle or to face each other. The semiconductor detector blocks may be freely moved in various directions such as directions along the moving radius of the above circle or along which the semiconductor detector blocks face. By positioning the electrode face of the semiconductor detector blocks at right angles to directions of the detected gamma rays, a positron emission tomography apparatus may be constructed to have a packing ratio (a ratio of a gamma ray detectable area to the entire area of the semiconductor plate) of 100%.

An agent containing a positron-emitting radionuclide is administered to a person or an animal, and two gamma rays generated by positron annihilation are subjected to coincidence measurement. The gamma rays are detected by the semiconductor plate of the semiconductor detector block, and electrons and holes are generated. Holes are collected into a platinum cathode and input into an amplifying circuit as a time information signal. Electrons are collected by an indium anode and flow into the amplifying circuit via the indium electrically resistive electrode face. At this time, signals are generated from the amplifiers connected to the four terminals on the four corners of the indium electrically resistive electrode face. The detected position of the gamma rays on the semiconductor plate face is determined using the signals. When the gamma rays are concurrently detected by adjacent two detectors due to Compton scattering, the detection closer to the subject may be determined to be a real detection position.

The resolution power of the semiconductor detector block may be enhanced as follows. First, a subject is irradiated by laser beams, and a reflected light of the laser beams is measured to determine a positional relationship between the surface of the subject and the detector block. Next, the semiconductor detector block is brought closer to the subject in consideration of the positional relationship to thereby carry out a three-dimensional position detection of the gamma rays. By enabling the semiconductor detector blocks to be independently and freely moved, it is possible to reduce distances between the semiconductor detector blocks which carry out a coincidence measurement for the subject which may have an arbitrary shape. When the distance between the semiconductor detector blocks is reduced and the coincidence measurement is carried out, a positron tomographic image having high sensitivity and high spatial resolution is obtainable. It is experimentally known that when the distance between the semiconductor detector blocks is reduced to 20 cm or less, the value of the spatial resolution becomes 1 mm or less. As such, the present invention may provide a positron distribution image having a spatial resolution of 1 mm or less.

The spatial resolution in the example positron emission tomography apparatus described in “Background Art” is about 3 mm. By using the semiconductor piece and thinning the detector, the resolution may be reduced to 1 mm or less. Therefore, it becomes possible to provide an environment for researching and developing a new medicinal substance using the positron emission tomography apparatus and a laboratory animal such as a mouse. Further, it is possible to find a micro cancer (carcinoma) having a size of, for example, 1 mm. Therefore, the semiconductor detector block and the positron emission tomography apparatus of the embodiment are expected to contribute to the development of new medicinal substances and eradication of cancers.

According to the present invention, it is possible to obtain a semiconductor detector block having a simple detector structure and performing a measurement with a spatial resolution of 1 mm or less, and a positron emission tomography apparatus having the semiconductor detector block.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

What is claimed is:

1. A semiconductor detector block comprising:
a plurality of semiconductor plates each configured to have a front surface on which an electrically resistive electrode is formed and a back surface on which an electrically conductive electrode is formed and to detect a two-dimensional detection position of gamma rays on each of the semiconductor plates using a ratio of electric signals from four corners of the electrically resistive electrode,
wherein the plurality of semiconductor plates are piled up and a three-dimensional detection position of the gamma rays is detectable using a ratio of the electric signals from the four corners of the electrically resistive electrodes.

2. The semiconductor detector block according to claim 1,
wherein a Schottky junction is formed between the electrically resistive electrode and the semiconductor plates.

3. The semiconductor detector block according to claim 1,
wherein the electrically resistive electrode is made of indium, the semiconductor plates are made of a CdTe crystal or a BrTl crystal, and the electrically conductive electrode is made of platinum.

4. The semiconductor detector block according to claim 3,
wherein faces of the electrically conductive electrodes of the adjacent semiconductor plates are connected by an electroconductive paste, and the electrically resistive electrodes are piled up while interposing an insulating film between surfaces of the electrically resistive electrodes.

5. The semiconductor detector block according to claim 4,
wherein an electrical signal from the electrically conductive electrodes of one of the semiconductor plates is used as a time signal to determine a coincidence measurement with the other semiconductor plates.

6. A positron emission tomography apparatus including two or more of the semiconductor detector blocks according to claim 5.

7. The positron emission tomography apparatus according to claim 6,
wherein the semiconductor detector blocks are independently movable in moving radius directions around a subject or directions facing the subject.
